(19) United States
(12) Patent Application Publication
(10) Pub. No.: US 2009/0016462 A1
(43) Pub. Date: Jan. 15, 2009

(54) Field bus application comprising several field devices

(75) Inventor: Eugenio Ferreira Da Silva Neto, Biel - Benken (CH)

Correspondence Address: BACON & THOMAS, PLLC, 625 SLATERS LANE, FOURTH FLOOR, ALEXANDRIA, VA, 22314-1176, US

(73) Assignee: Endress + Hauser Process Solutions AG, Reinach (CH)

(21) Appl. No.: 11/664,600

(22) PCT Filed: Oct. 5, 2005
(86) PCT No.: PCT/EP2005/054997

§ 371 Date: Jul. 29, 2008

(30) Foreign Application Priority Data
Oct. 5, 2004 (DE) 10 2004 048 766.9

(51) Int. Cl. G05B 19/042

(52) U.S. Cl. 375/295

(57) ABSTRACT

In a fieldbus application with multiple field devices, in addition to a fieldbus serving as a wire-based communication network (CN1), a radio communication network (CN2) is provided, which enables a data communication between the individual field devices (F1, F2, F3, WAP) independent of the wire-based communication network (CN1).

The invention relates to a fieldbus application with a plurality of field devices, as defined in the preamble of claim 1.

In the technology of process automation, field devices are used in many cases for registering and/or influencing process variables. Examples of such field devices are fill level measuring devices, mass flow (e.g. mass flow rate) measuring devices, pressure and temperature measuring devices, etc., which, as sensors, register the corresponding process variables, respectively, fill level, mass flow, pressure, and temperature.

Serving for influencing process variables are actuators, which, e.g. as valves, can change the flow rate of a fluid in a section of pipeline, or, as pumps, can change the fill level in a container.

In principle, all devices, which are used at a process component, and which deliver, process, or store process-relevant information, are referred to as “field devices”.

A variety of field devices are produced and sold by the firm Endress+Hauser.

As a rule, field devices in modern manufacturing plants are connected via bus systems (Profibus, Foundation Fieldbus, etc.) with superordinated units (e.g. control systems or control units). Among other things, these superordinated units serve for process control, process visualization, process monitoring, as well as for startup of field devices. Via fieldbus systems, an exchange of digital information is possible between the field devices and the superordinated units.

Today's fieldbus systems are designed essentially for the tasks of communicating measurement data and control data. The protocols and services used are correspondingly adapted to these tasks. For additional tasks, fieldbus systems are completely unsuitable, or only conditionally suitable. Thus, the start-up of a fieldbus, especially the configuring and parametering of the individual field devices, is very time-consuming.

The appropriate data must be transferred to each individual field device via the fieldbus which, for the most part, permits only a low data transfer rate.

A further disadvantage of the known systems is that, at a process component, e.g. a storage tank, no information whatsoever is available concerning the process component or the application. Furthermore, none of the field devices at a process component possesses information about the other field devices arranged in its immediate surroundings.

An object of the invention is, therefore, to provide a fieldbus application of a plurality of field devices, which does not have the abovementioned disadvantages, and which, especially, enables improved communication between the field devices.

This object is achieved through the features defined in claim 1.

Further developments of the invention are described in the dependent claims.

An essential idea of the invention is that, in addition to the fieldbus system, as a first communication network, a second wirelessly-functioning radio network is provided between the field devices. Via the radio network, additional data can be exchanged between the field devices, independently of the wire-based fieldbus network. The field devices have corresponding radio modules for communicating via the radio network.

In simple manner, the radio network is limited only to the immediate vicinity of a process component.

In order to facilitate the start-up of the fieldbus system, a field device at the process component is configured as network node with sufficient storage capacity, especially for configuration data.

The start-up of the radio network should be as simple as possible to execute. Therefore, the radio modules are constructed such that they enable an automatic organization of the radio network.

In a further development of the invention, the radio network is embodied in mesh technology.

The invention will now be described in greater detail on the basis of an example of an embodiment illustrated in the drawing, the figures of which show as follows:

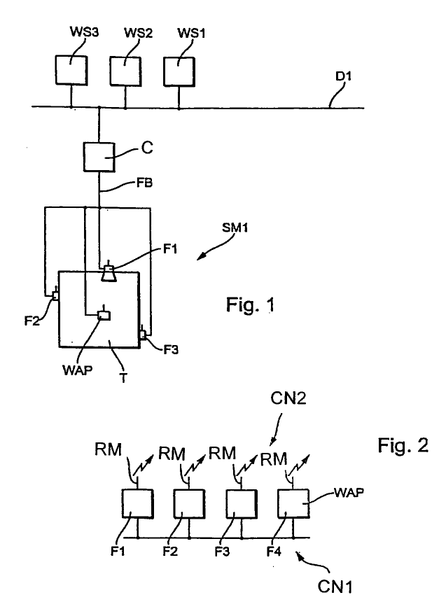

FIG. 1 a fieldbus system; and

FIG. 2 a plurality of field devices of a fieldbus system.

In FIG. 1, a fieldbus system used in process automation technology is shown in greater detail. A plurality of computer units (workstations) WS1, WS2, WS3 are connected to a data bus D1. These computer units serve as superordinated units, e.g. for process visualization, process monitoring, process control, engineering, or plant monitoring. Data bus D1 functions, for example, according to the Profibus DP standard, or the Foundation Fieldbus HSE (high-speed Ethernet standard). Via a connecting unit C, the data bus D1 is connected with a fieldbus segment SM1. The connecting unit C can be a simple network bridge (e.g. a gateway, linking device, or segment coupler), or a more complex controller (e.g. a PLC or a control system). The fieldbus segment SM1 is composed essentially of multiple field devices F1, F2, F3, WAP (wireless access point) arranged at a storage tank T, which field devices are connected with one another via a fieldbus FB. The field devices F1, F2, F3 involve both sensors and actuators. In the illustrated case, the field device WAP is not used directly for process control. The fieldbus functions according to one of the known communications standards in the field of process automation technology: Profibus, Foundation Fieldbus, or HART.

The way in which the invention functions will now be described in greater detail.

The field devices F1, F2, F3 communicate with each other conventionally (wire-based) via the fieldbus FB, or with the computer units WS1, WS2, or WS3 via the connecting unit C. As a rule, measurement data recorded by the sensors and control data for the actuators are communicated via the fieldbus FB. The fieldbus FB serves as a wire-based, first communication network CN1.

In addition to this wire-based communication network CN1, the field devices F1, F2, F3, WAP are connected with each other via a further communication network CN2, which is a radio network. For this purpose, the field devices F1, F2, F3, WAP have corresponding radio modules RM.

The radio communication network CN2 serves essentially for transferring additional information, such as e.g. configuring data and parametering data, in the vicinity of a process component. The radio communication network CN2 is therefore limited to an area near a process component. Data in the radio communication network CN2 must also be transmittable when the fieldbus FB is not working or not yet working, or when a new field device is installed at a process component, the storage tank T, and this new field device cannot yet communicate via the fieldbus.

Furthermore, no specially-trained personnel should be necessary for configuring the radio communication network CN2.

Therefore, the radio modules RM are constructed such that they enable an automatic organization of the radio communication network CN2. Such ad-hoc radio networks are already known. In such networks, a new participant, i.e. a new field device, is automatically recognized and integrated into the network.

The field device WAP serves as network node and, consequently, central unit in the radio communication network CN2. Thus, by querying the individual radio modules RM, the field device WAP can, among other things, recognize which field devices are arranged in its immediate vicinity.

When the field device WAP has information concerning the process components, in this case the storage tank, and concerning the corresponding application, e.g. “overflow protection,” then corresponding configuring and parametering values can be selected from a predetermined data set, which is stored in the field device WAP, and transferred via radio to the field devices F1, F2, F3.

When necessary, the field device WAP can, using an intelligent software, independently conclude, from the information that “field device F1 is a fill level sensor, field device F2 is a valve, and field device F3 is a flow meter”, that the application concerns overflow protection at a storage tank.

In the field device WAP, there is enough storage capacity present to store a variety of data (application data, start-up data, etc.), as well as more complex program routines.

Furthermore, the possibility exists to execute a more complex application, e.g. an expert system for diagnostics, in the field device WAP. Here, complex diagnostic processes, which require the most varied of information, e.g. from multiple field devices, can also run. The field device WAP is also very well-suited for condition monitoring of the field devices at the storage tank T.

Additionally, a GPS system can be installed in the field device WAP, which makes available a real-time clock, in order to be able to determine e.g. events and alarms very accurately as to time.

The field device WAP can also generate a list (life list) of the field devices connected to the fieldbus segment SM1. If this fieldbus-based life list deviates from a participants list of the radio communication network CN2, it can be simply determined in the field device WAP that a new field device has been connected to the fieldbus segment SM1.

In a further development of the invention, the field device WAP can also communicate via radio with a superordinated unit WS1, WS2, WS3, or with the connecting device C, or with a field device provided at another process component and constructed correspondingly to the field device WAP.

In a much simpler embodiment, the field device WAP has no connection with the fieldbus FB.

FIG. 2 is for clarifying, once again, how the field devices F1, F2, F3 and WAP communicate independently of one another via the two communication networks CN1 and CN2. The radio communication network CN2 can, in such case, be adapted to the corresponding tasks significantly easier and faster. The radio communication network CN2 is not specifically designed for transferring measurement data and control data.

The field device WAP essentially serves as network node (wireless access point) at a process component. Above all, it permits, without great effort, automatic querying and recognition of field devices in its immediate vicinity. It facilitates and supports the start-up of field devices at a process component. The radio communication network CN2 permits functionalities which a fieldbus system does not allow.

Via the radio communication network CN2, field devices, e.g. the field device F1, can be easily configured and/or parametered from a portable computer unit (laptop, notebook, Palm), which has a corresponding radio interface, and/or status information or process values can be displayed. The user must only enter into the range of the radio communication network CN2, that is, into the vicinity of the storage tank T, with his/her computer. Without the need to establish a cabled connection between the computer unit and the field device or fieldbus, the user can service individual field devices.

1-5. (canceled)

6. A fieldbus application including:
an automation fieldbus FB; and
a plurality of field devices (F1, F2, F3, WAP), which are connected with said automation fieldbus FB, wherein:
said automation fieldbus serves as a wire-based communication network (CN1);
and
said plurality of field devices each have radio modules (RM), which together form a radio network (CN2), which enables a data communication between the individual field devices (F1, F2, F3, WAP) independent of the wire-based communication network (CN1).

7. The fieldbus application as claimed in claim 6, wherein:
said radio network is limited to an immediate vicinity of a process component.

8. The fieldbus application as claimed in claim 7 wherein:
one of said field device (WAP) is provided at the process component and forms as a network node of the radio network (CN2).

9. The field device application as claimed in claim 6, wherein:
said radio modules (RM) are embodied such that organization of the radio network occurs automatically.

10. The fieldbus application as claimed in claim 9, wherein:
said radio network (CN2) is embodied in mesh technology.
